(19) United States
(12) Patent Application Publication
(10) Pub. No.: US 2016/0321579 A1
(43) Pub. Date: Nov. 3, 2016

(54) SIMULATION BASED CLOUD SERVICE FOR INDUSTRIAL ENERGY MANAGEMENT

(71) Applicant: Siemens Aktiengesellschaft, Munich (DE)

(72) Inventor: Dong Wei, Edison, NJ (US)

(21) Appl. No.: 14/697,975

(22) Filed: Apr. 28, 2015

(51) Int. Cl. G06Q 10/06

(52) U.S. Cl. CPC G06Q 10/0633; G06Q 10/067

(57) ABSTRACT

A method for industrial energy management based on simulation of a production line. The method includes providing production line infrastructure, production, meter, log and resource data for the production line, wherein the data is stored in at least one computer data server at a manufacturing facility. The method also includes providing plant simulation capability that resides on a plant simulation server located in a separate location than the data server, wherein the plant simulation capability includes a decision tree based energy optimization engine. Further, the method includes providing at least one output from the decision tree based energy optimization engine that is based on the data, wherein the output includes at least one of a production bottleneck analysis, an energy consumption analysis for production line equipment.

### FIELD OF THE INVENTION

This invention to industrial energy management, and more particularly, to a method for industrial energy management based on simulation of a production line that includes providing plant simulation capability that is accessible via a cloud computing service, wherein the plant simulation includes a decision tree based energy optimization engine, and providing at least one output from the decision tree based energy optimization engine that is based on production line infrastructure, production, meter, log and resource data for the production line, wherein the data is stored at a manufacturing facility

### BACKGROUND OF THE INVENTION

Based on current trends, world energy demand will approximately double in the next few decades. This increase in demand, coupled with costs associated with CO₂ emissions, has already caused significant growth in energy prices. Many manufacturing facilities were designed to optimize production, product delivery time, process control and product quality. However, energy usage may have not been optimized or considered in the design of many manufacturing facilities.

Referring to FIG. 1, exemplary power or energy consumption states (i.e. p) during periods of operation of a single motorized machine are shown. During a set-up period 10, power usage increases as the machine speeds up to a setting speed and is prepared for normal operation. During operational periods 12, 14, the machine runs at the setting speed, but without real load, and power is at a setting speed level pₛ. For example, an operational period occurs when the machine is waiting for incoming material from an upstream machine (i.e. starvation) or waiting for a downstream machine to become available (i.e. blockage). During a working period 16, the machine is in a production phase, with real load, and power rises to a working level p_{w} that is higher than the setting speed level pₛ. During a standby period 18, the machine runs at a lower speed than the setting speed and power is reduced to a standby level p_{sb} that is lower than the setting speed level pₛ. During a fault period 20, power is reduced further to a fault level p_{f} lower than the standby level p_{f}. In FIG. 1, Tₛₑₜ, Tₒₚₑ, T_{work}, T_{standby} and T_{fault} denote the time for the set-up 10, operational 12,14, working 16, standby 18 and fault 20 periods, respectively.

There are several technologies or solutions available for saving energy. These include reducing power levels by replacing current motors with high-efficiency motors and drives. Further, industrial energy management software is available. However, implementation of such solutions is difficult for small and medium sized businesses due to their complexity and cost.

### SUMMARY OF THE INVENTION

A method for industrial energy management based on simulation of a production line is disclosed. The method includes providing production line infrastructure, production, meter/submeter, log and resource data for the production line, wherein the data is stored in at least one computer data server at a manufacturing facility. The method also includes providing plant simulation capability that resides on a plant simulation server located in a separate location than the data server, wherein the plant simulation capability includes a decision tree based energy optimization engine. Further, the method includes providing at least one output from the decision tree based energy optimization engine that is based on the data, wherein the output includes at least one of a production bottleneck analysis, an energy consumption analysis for production line equipment.

Those skilled in the art may apply the respective features of the present invention jointly or severally in any combination or sub-combination.

### BRIEF DESCRIPTION OF THE DRAWINGS

The teachings of the present invention can be readily understood by considering the following detailed description in conjunction with the accompanying drawings, in which:

FIG. 1 depicts exemplary power or energy consumption states during periods of operation of a single motorized machine.

FIG. 2 is a block diagram for a decision tree based energy optimization engine.

FIG. 3 depicts an exemplary computer interface which shows an power profile for an oven on a production line.

FIG. 4 is an exemplary bar chart wherein each bar indicates energy consumption for a piece of equipment on a production line.

FIG. 5 depicts an architecture for a cloud service for industrial energy management in accordance with the invention.

FIG. 6 is a high level block diagram of a computer used in the invention.

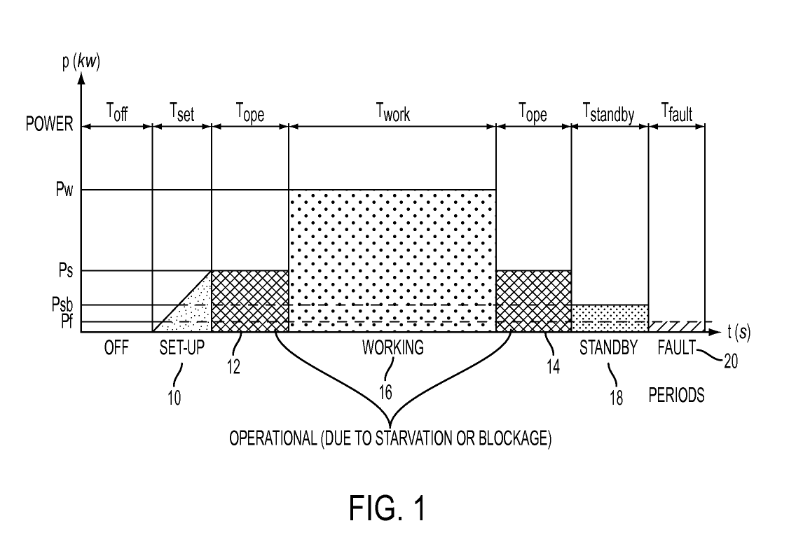

To facilitate understanding, identical reference numerals have been used, where possible, to designate identical elements that are common to the figures.

### DESCRIPTION OF THE INVENTION

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The implementation of energy saving solutions is difficult for small and medium sized manufacturers due to their complexity and lack of domain knowledge. For example, a production manager may not be familiar with how to respond to a request from an electric utility (i.e. a demand response signal) in which electricity usage is reduced or shifted during peak periods in exchange for time-based rates or other form of financial incentive. Further, it is desirable to integrate energy, performance and business processes into a single platform.

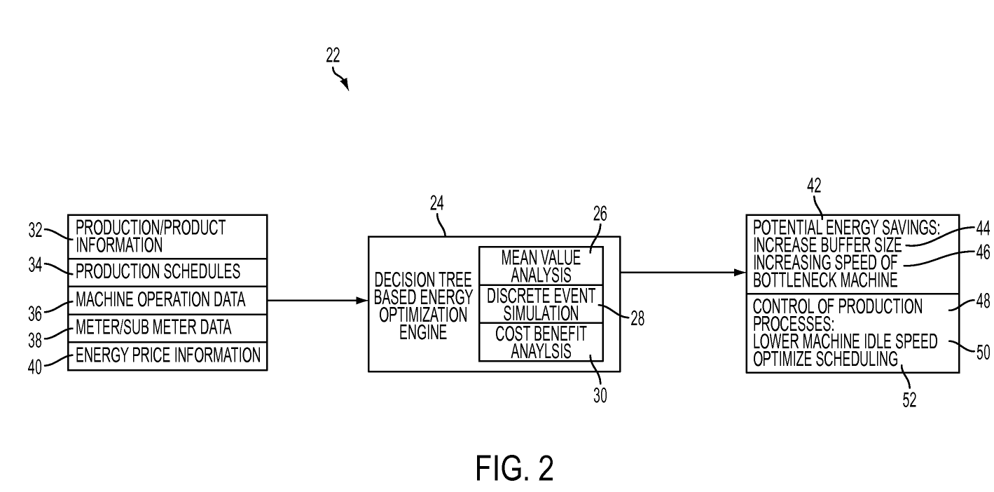

With respect to a production line in a manufacturing facility, T indicates the time interval during which P units must be produced by the production line. Elasticity may be defined as to what extent the production line is able to reduce its overall energy consumption and energy cost with respect to demand response signals with given T and P. A decision tree based energy optimization engine that utilizes elasticity as a parameter may be used to evaluate and assess potential energy-saving improvements and provide optimal control of production processes. Referring to FIG. 2, a block diagram 22 for a decision tree based energy optimization engine (i.e. DTEOE) 24 is shown. In an embodiment, the DTEOE 24 provides a method for finding existing and potential sources of elasticity for energy demand management in a production flow line. In particular, the DTEOE 24 may utilize mean value analysis 26, discrete event simulation 28 and cost benefit analysis 30. Inputs to the DTEOE 24 include production/product information 32, production schedules 34, machine operation data 36, meter/sub-meter data 38, energy price information 40 and other information. Outputs from the DTEOE 24 include the identification of potential energy savings 42 by, for example, increasing buffer size 44 and/or increasing a speed of a machine that is causing a production bottleneck 46, and/or by controlling selected production processes 48 such as lowering a machine idle speed 50, optimizing scheduling 52 and others. In this regard, the disclosure of copending International Publication Number WO 2014/039290, International Application No. PCT/US2013/056404 having an international filing date of Aug. 23, 2013 and entitled METHOD FOR ENERGY DEMAND MANAGEMENT IN A PRODUCTION FLOW LINE, and that of copending U.S. national stage application Ser. No. 14/426,170, filed on Mar. 5, 2015 and entitled METHOD FOR ENERGY DEMAND MANAGEMENT IN A PRODUCTION FLOW LINE, both assigned to Siemens, the assignee herein, are incorporated by reference in their entirety.

In accordance with the invention, DTEOE 24 is integrated into known simulation software for manufacturing plants such as Tecnomatix® Plant Simulation computer software available from Siemens. In particular, DTEOE 24 may be utilized as an Application-as-a-Service (i.e. AaaS) that serves as an auxiliary engineering/audit tool to assist in locating bottleneck stations in a production line and quantify potential energy savings when the configuration of a machine and/or buffer is changed. DTEOE 24 may also be used as an auxiliary audit tool to assist in monitoring equipment condition based on historical energy data and suggest maintenance when energy efficiency is degraded. In addition, DTEOE 24 serves as a run-time system to minimize energy consumption for a given product number and delivery due date. Further, DTEOE 24 serves as a run-time system to minimize energy cost for a given product number, delivery due date and energy price/demand response signal from the utility.

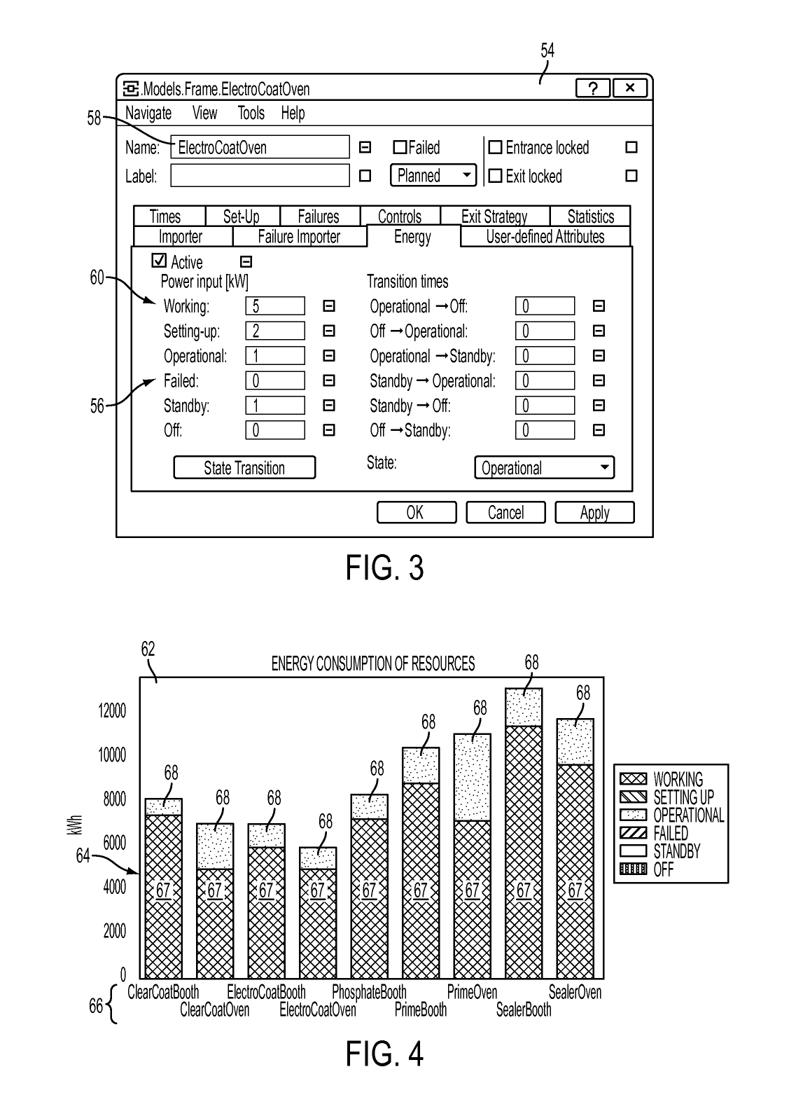

Referring to FIG. 3, an exemplary computer interface 54 is shown that depicts a power profile 56 for an oven 58 on a production line. In particular, the profile 56 depicts power input 60 to the oven 58. It is understood that the current invention is applicable to reducing energy consumption of motorized equipment and non-motorized equipment such as ovens, furnaces, heaters and other types of equipment. Referring to FIG. 4, an exemplary bar chart 62 is shown that includes a plurality of bars 64 wherein each bar 64 indicates energy consumption for an associated piece of equipment 66 on a production line. Lower portion 67 of each bar 64 indicates energy consumption during a working period 16, as previously described, for the associated equipment 66. Top section 68 of each bar 64 indicates energy consumption during an operational period 12,14, as previously described, for the associated equipment 66 thus indicating that the energy is consumed during a non-production operation. It is desirable to improve operation of the production line so as to minimize the amount of energy consumed during a non-production operation.

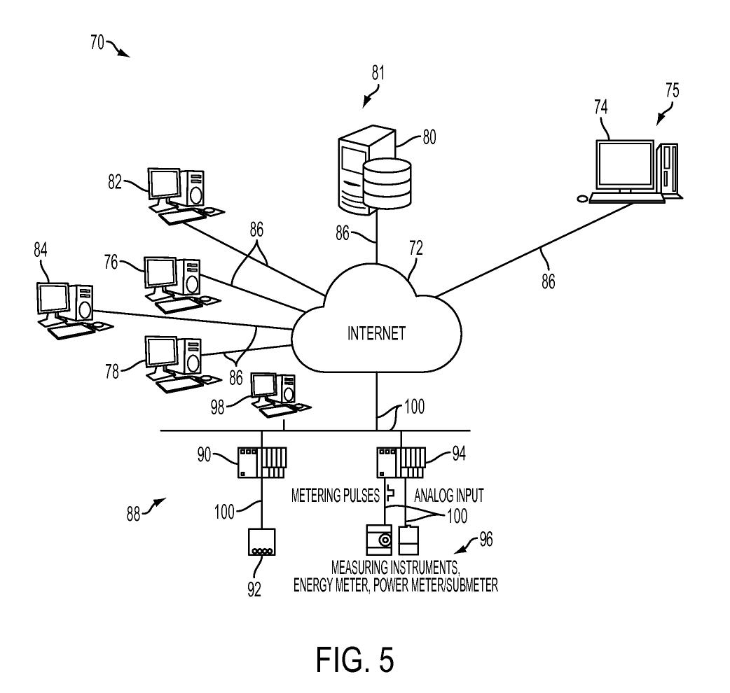

Referring to FIG. 5, an architecture 70 for a cloud service for industrial energy management in accordance with the invention is shown. In an embodiment, the current invention is configured to operate in a cloud computing environment that includes cloud computing services 75 and 81 that utilize plant simulation/DTEOE (i.e. DTEOE) 74 and energy data management 80 servers, respectively. Cloud computing provides access to computing resources such as networks, network bandwidth, servers, processing, memory, storage, applications, virtual machines, services, software and others that reside on the Internet. In accordance with the invention, DTEOE 24 is integrated into known plant simulation software for manufacturing plants such as Tecnomatix® Plant Simulation computer software. The plant simulation software is run on the DTEOE server 74 located at a first facility having personnel that are trained and experienced in operation of the plant simulation software and DTEOE 24. In an alternate embodiment, the DTEOE server 74 is located at a cloud service provider facility. The architecture 70 also includes a plurality of servers located at a facility that is separate from the first facility, such as a manufacturing facility of a small to medium size manufacturer or other customer. It understood that the servers may be located at more than one manufacturing facility. The manufacturer can save all related data on the servers. For example, production line infrastructure data, i.e. a production line model, is stored on a product lifetime management (i.e. PLM) server 76 having PLM software such as Siemens PLM Software that, for example, integrates and manages data, processes and business systems throughout the lifecycle of a product. Production data is stored in a manufacturing execution system (i.e. MES) server 78 having MES software that for example, manages and monitors work that is in process on a factory floor. In addition, meter and log data is stored in the energy data management server 80 having software that, for example, optimizes energy data management. For example, SIMATIC B.data servers hosted by Siemens may be used. The energy data management server 80 may have an associated client 82. Further, resource data such as electricity price and demand response signals are stored in an enterprise resource planning (i.e. ERP) server 84 having ERP software that, for example, serves as business management software for collecting, storing, managing and interpreting data from business activities. The DTEOE 74, PLM 76, MES 78, energy data management 80, and ERP 84 servers are connected to the Internet 72 by an Intranet that forms part of an enterprise network 86. Alternatively, the DTEOE 74, PLM 76, MES 78, energy data management 80, and ERP 84 servers may be part of a cloud computing service.

The meter and log data is acquired by a data acquisition system 88 that includes a first substation programmable logic controller (i.e. PLC) 90 connected to at least one power monitoring device 92 and a second substation PLC 94 connected to measuring instruments 96 such as, for example, energy and power meters/submeters. The first 90 and second 94 substation PLCs serve to collect data and process signals, such as by filtering the signals to remove noise. By way of example, the first 90 and second 94 substation PLCs may be SIMATIC® S7-300 universal controllers available from Siemens. The data is then compressed in order to save bandwidth and sent to the energy data management server 80 via the Internet 72. The first substation PLC 90 receives information from the power monitoring devices 92 regarding, for example, power consumption and power quality. By way of example, the power monitoring device may be a SENTRON® PAC3200 power monitoring device available from Siemens. The second substation PLC 94 sends metering pulses to the measuring instruments 96 to poll the meters and collect meter data. The measuring instruments 96 provide analog inputs to the second substation PLC 94, such as data regarding temperature, pressure, flow rate and other parameters, which is read by the second substation PLC 94 as real-time data. The data acquisition system 88 also includes a human-machine interface (i.e. HMI) 98 that is used by an operator to read collected data. The first 90 and second 94 substation PLCs, power monitoring device 92, measuring instruments 96 and HMI 98 are connected to the Internet 72 via a known factory automation network 100.

In use, the DTEOE server 74 receives energy price data and demand response signals from the ERP server 84, product and order data from the MES server 78, energy historical data from the energy data management server 80 and production line configuration information from the PLM server 76. The data received from the ERP 84, MES 78, energy data management 80 and PLM 76 servers is then used by the plant simulation software and DTEOE 24 to provide DTEOE outputs. Outputs from the DTEOE server 74 include production bottleneck analysis and retrofitting suggestions to PLM server 76. In addition, the DTEOE server 74 provides energy consumption analysis for production line equipment and maintenance suggestions if the energy performance is degraded. Further, the DTEOE server 74 provides optimized production schedules that are used by the MES server 78 to minimize energy consumption or minimize energy cost based on real-time energy price and demand response signals. In an embodiment, a cloud service provider can charge customers per use.

In accordance with the invention, a small or medium sized manufacturer is able to model and simulate their production processes in order to improve energy efficiency and reduce energy cost without having to own, model or operate plant simulation software. This may be accomplished, for example, by retrofitting components of a production line and/or generating optimized production schedules.

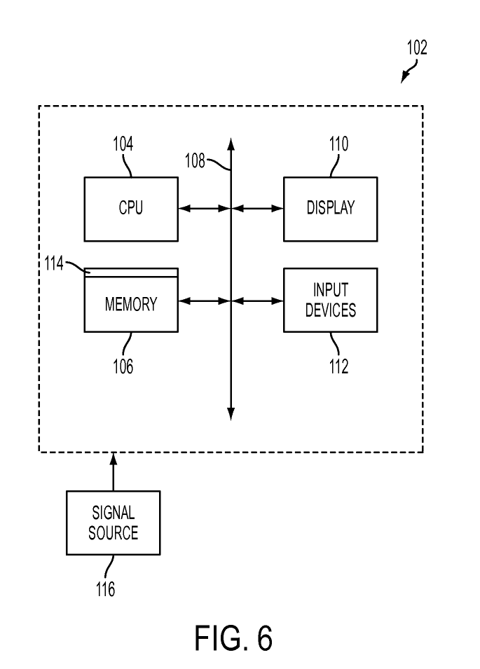

The current invention may be implemented by using a computer system. A high level block diagram of a computer system 102 is illustrated in FIG. 6. The computer system 102 may use well known computer processors, memory units, storage devices, computer software and other components. The computer system 102 can comprise, inter alia, a central processing unit (CPU) 104, a memory 106 and an input/output (I/O) interface 108. The computer system 102 is generally coupled through the I/O interface 108 to a display 110 and various input devices 112 such as a mouse and keyboard. The support circuits can include circuits such as cache, power supplies, clock circuits, and a communications bus. The memory 106 can include random access memory (RAM), read only memory (ROM), disk drive, tape drive, etc., or a combination thereof. The present invention can be implemented as a routine 114 that is stored in memory 106 and executed by the CPU 104 to process a signal from a signal source 116. As such, the computer system 102 is a general-purpose computer system that becomes a specific purpose computer system when executing the routine 114 of the present invention. The computer system 102 can communicate with one or more networks such as a local area network (LAN), a general wide area network (WAN), and/or a public network (e.g., the Internet) via a network adapter. In addition the computer system 102 may be used as a server as part of a cloud computing system where tasks are performed by remote processing devices that are linked through a communications network. In a distributed cloud computing environment, program modules may be located in both local and remote computer system storage media including memory storage devices.

The computer system 102 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device. Examples of well-known computing systems, environments, and/or configurations that may be suitable for use with computer system 102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present invention.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

What is claimed is:

1. A method for industrial energy management based on simulation of a production line, comprising:
providing production line infrastructure, production, meter, log and resource data for the production line, wherein the data is stored at a manufacturing facility;
providing plant simulation capability that is accessible via a cloud computing service, wherein the plant simulation includes a decision tree based energy optimization engine; and
providing at least one output from the decision tree based energy optimization engine that is based on the data, wherein the output includes a production bottleneck analysis.

2. The method according to claim 1, wherein the output includes energy consumption analysis for production line equipment.

3. The method according to claim 1, wherein the output includes optimized production schedules.

4. The method according to claim 1, wherein the production line infrastructure data includes a production line model.

5. The method according to claim 1, wherein the resource data includes electricity price and demand response signals.

6. A method for industrial energy management based on simulation of a production line, comprising:
providing production line infrastructure, production, meter, log and resource data for the production line, wherein the data is stored in at least one computer data server at a manufacturing facility;
providing plant simulation capability that resides on a plant simulation server located in a separate location than the data server, wherein the plant simulation capability includes a decision tree based energy optimization engine; and
providing at least one output from the decision tree based energy optimization engine that is based on the data, wherein the output includes a production bottleneck analysis.

7. The method according to claim 6, wherein the output includes energy consumption analysis for production line equipment.

8. The method according to claim 6, wherein the output includes optimized production schedules.

9. The method according to claim 6, wherein the production line infrastructure data includes a production line model.

10. The method according to claim 6, wherein the resource data includes electricity price and demand response signals.

11. A method in a computer system for industrial energy management based on simulation of a production line, comprising:
providing a data acquisition system for acquiring meter and log data for the production line;
providing production line infrastructure, production and resource data for the production line, wherein the production line infrastructure, production and resource data and the meter and log data are stored in at least one computer data server at a manufacturing facility;
providing plant simulation capability that resides on a plant simulation server located in a separate location than the data server, wherein the plant simulation capability includes a decision tree based energy optimization engine; and
providing at least one output from the decision tree based energy optimization engine that is based on the data, wherein the output includes a production bottleneck analysis.

12. The method according to claim 11, wherein the output includes energy consumption analysis for production line equipment.

13. The method according to claim 11, wherein the output includes optimized production schedules.

14. The method according to claim 11, wherein the production line infrastructure data includes a production line model.

15. The method according to claim 11, wherein the resource data includes electricity price and demand response signals.

16. The method according to claim 11, wherein the decision tree based energy optimization engine utilizes mean value analysis.

17. The method according to claim 11, wherein the decision tree based energy optimization engine utilizes discrete event simulation.

18. The method according to claim 11, wherein the decision tree based energy optimization engine utilizes cost benefit analysis.

19. The method according to claim 11, wherein the data acquisition system includes at least one programmable logic controller.

20. The method according to claim 11, wherein the data acquisition system includes a power monitoring device.
